(19) United States
(12) Patent Application Publication
(10) Pub. No.: US 2014/0116710 A1
(43) Pub. Date: May 1, 2014

(54) TREATMENT OF SHALE FORMATONS USING A CHELATING AGENT

(71) Applicants: Hisham Naser-El-Din, College Station, TX (US); Cornelia Adriana De Wolf, Eerbeek (NL); Mohamed Ahmed Nasr-El-Din Mahmoud, Dhahran (SA)

(72) Inventors: Hisham Naser-El-Din, College Station, TX (US); Cornelia Adriana De Wolf, Eerbeek (NL); Mohamed Ahmed Nasr-El-Din Mahmoud, Dhahran (SA)

(73) Assignee: AKZO NOBEL CHEMICALS INTERNATIONAL B.V., Amersfoort (NL)

(21) Appl. No.: 14/124,831

(22) PCT Filed: Jun. 11, 2012
(86) PCT No.: PCT/EP2012/060950

§ 371 Date: Dec. 9, 2013

Related U.S. Application Data
(60) Provisional application No. 61/496,179, filed on Jun. 13, 2011.

(30) Foreign Application Priority Data
Jul. 6, 2011 (EP) 11172813.5

(51) Int. Cl. C08K 5/16

(52) U.S. Cl. CPC C08K 5/16
USPC 166/308.3

(57) ABSTRACT

The present invention relates to a process for treating a shale formation comprising introducing a fluid containing glutamic acid N,N-diacetic acid or a salt thereof (GLDA), methylglycine N,N-diacetic acid or a salt thereof (MGDA),and/or N- hydroxyethyl ethylenediamine N,N′,N′-triacetic acid or a salt thereof (HEDTA) into the formation which process may optionally contain an additional fracturing step.

The present invention relates to a process for treating shale formations with a fluid that contains glutamic acid N,N-diacetic acid or a salt thereof (GLDA), methylglycine N,N-diacetic acid or a salt thereof (MGDA), and/or N-hydroxyethyl ethylenediamine N,N′,N′-triacetic acid or a salt thereof (HEDTA).

Subterranean formations from which oil and/or gas can be recovered can contain several solid materials contained in porous or fractured rock formations. The naturally occurring hydrocarbons, such as oil and/or gas, are trapped by the overlying rock formations with lower permeability. The reservoirs are found using hydrocarbon exploration methods and often one of the purposes of withdrawing the oil and/or gas therefrom is to improve the permeability of the formations. The rock formations can be distinguished by their major components and one category is formed by the so-called shale formations, which contain very fine particles of many different clays covered with organic materials to which gas and/or oil are adsorbed. Shale amongst others contains many clay minerals like kaolinite, illite, chlorite, smectite, and montmorillonite and as well, quartz, feldspars, carbonates, pyrite, organic matter, and cherts.

One process to make a formation more permeable is a matrix acidizing process, wherein an acidic fluid is introduced into the formations trapping the oil and/or gas, the acidic fluid dissolving the carbonate and creating high permeability streaks, which enhances well performance.

In the oil industry, there are two generally recognized ways to improve the flow of oil or gas from shale, matrix acidizing and hydraulic fracturing. In the first process acids are applied to partly dissolve the shale rock, thus creating flow channels and increasing the permeability of the formation. In the second treatment pressure is applied to open the shale formation by creating fractures. The common way to explore oil and/or gas from shale formations by hydraulic fracturing is treatment with water at neutral pH. Reactive fluids are better as they etch the surface of the fractures, creating flow channels which enhance the conductivity of the fracture and rock permeability around the fracture. The choice between acidizing or hydraulic fracturing is often determined by the natural permeability of the shale formation. Hydraulic fracturing is more often preferred in a lower permeability shale.

SPE 106815, Surface Reactive Fluid's Effect on Shale, from Bill Grieser et al., presented at the 2007 SPE Production and Operations Symposium held in Oklahoma City Okla. USA, Mar. 31-Apr. 3, 2007, discloses that though shale only exhibits an insignificant bulk solubility in acids, reactive fluids seem to be capable of enhancing gas diffusion into and through narrow-aperture induced fractures and increasing surface area for flow of gas from the shale matrix. The reactive fluid tested in this document is a fluid containing 3 wt % HCl or a fluid containing 5 wt % acetic acid. The reactive fluid is said to cause the shale to become acid-etched and gas to flow.

U.S. Pat. No. 3,700,280 discloses the production of oil from a shale formation using a chelating agent such as EDTA. In this document it is indicated that for removing the oil from the shale a first step involves treating the shale with a high temperature fluid or steam and then subsequently recovering the decomposed dawsonite in the shale with a chelating agent solution. U.S. Pat. No. 3,700,028 does not disclose the use of GLDA, MGDA, and/or HEDTA, nor does it acknowledge the exploration of oil and/or gas by an acidificaton or acid etching step.

GB 2420577 discloses an aqueous fluid containing a choline salt to reduce shale swelling. It is said that scale control additives may be added which can be a chelating agent like for example a salt of EDTA or NTA.

U.S. 2006/0073984 discloses a fracturing fluid containing a chelating agent chosen from a group of alternatives, such as for example HEDTA, that serves as a shale hydration inhibition agent, an agent that prevents a fractured shale formation to swell. Nowhere in this document it is disclosed or suggested that the fluid described therein that may contain HEDTA serves to treat the fractured shale formation as defined herein i.e. to increase permeability by partly dissolving the formation, remove small particles and/or inorganic scale. In addition this document does not contain any hint to choose HEDTA from the list of alternatives disclosed.

WO 2009/086954 discloses the good solubility of GLDA in acidic solutions. Because of this good solubility, the document discloses the use of GLDA as a chemical in the oil field for example in a fracturing process. However, this document does not explicitly disclose a process to treat a subterranean shale formation comprising a fluid containing GLDA to achieve a treatment of the formation i.e. to increase permeability by at least partly dissolving the formation, remove small particles and/or inorganic scale. Also in this document no suggestion is made that a fluid containing GLDA would be capable of achieving a beneficial effect in a shale formation.

U.S. 2008/200354 discloses a method to clean a wellbore that contains a filter cake with a fluid containing an iminodiacetic acid. The iminodiacetic acid may be selected from a group of compounds, also listing GLDA. The document specifies that filter cakes can give superior stability in shale formations, and as such that the breaker fluid can be used in several well types, but the breaker fluid is only disclosed to break down the filter cake and no disclosure of it having any effect on the formation itself is made.

Shale formations contain various types of clay minerals and a high concentration of very fine particles. As a result, the use of acids like HCl, phosphoric acid or acetic acid will give an insufficient acid etching effect. In addition, contacting shale with these acids was found to give poor results in some cases, for example acetic acid leads to undesired swelling effects in the formation, hydrogen chloride to undesired corrosivity side effects, and phosphoric acid is highly undesired in the environment. The capability of the conventional acids to desorb oil and/or gas from the shale formation was also found to be subject to improvement.

An effective reactive fluid should be compatible with the asphaltene in the kerogen, prevent iron precipitation, be compatible with the clays, give no environmental issue with flow back, give better flowback, have low viscosity so it can penetrate into the small fractures and micro channels, dissolve carbonates and other inorganic components, and help to release the adsorbed oil/gas from the organic layer.

The present invention aims to provide a process in which many of the above attendant disadvantages of treating shale with an acid like HCl are avoided and which leads to the benefits as indicated above.

It has been found that when using a fluid for the formation treatment in which GLDA, MGDA, and/or HEDTA are used, the above disadvantages are avoided to a great extent and further improvements in exploring oil and/or gas from the shale were found.

Accordingly, the present invention provides a process for treating a shale formation comprising introducing a fluid containing L-glutamic acid N,N-diacetic acid or a salt thereof (GLDA), methylglycine N,N-diacetic acid or a salt thereof (MGDA), and/or N-hydroxyethyl ethylenediamine N,N′,N′-triacetic acid or a salt thereof (HEDTA) into the formation.

The term treating in this application is intended to cover any treatment of the formation with the fluid. It specifically covers treating the shale formation with the fluid to achieve at least one of (i) an increased permeability by at least partial dissolution of the formation, (ii) the removal of small particles, and (iii) the removal of inorganic scale, and so enhance the well performance and enable an increased production of oil and/or gas from the formation. At the same time it may cover cleaning of the wellbore and descaling of the oil/gas production well and production equipment.

When the treatment as indicated above, resulting in increased permeability by at least partial dissolution of the formation, is done with an acidic fluid at a pressure below the fracture pressure of the formation, the treatment is normally understood to be an acidizing treatment. When done above fracture pressure, the same treatment is considered an acidic fracturing treatment. Both acidizing treatment processes and acidic fracturing treatment processes are covered by the present invention.

Surprisingly, it was found that GLDA, MGDA, and HEDTA do not degrade the shale in the formation to give many small particles, as is the case with acidic treatment fluids based on other acids like HCl. GLDA, MGDA, and/or HEDTA act much more selectively on the carbonate in the formation and dissolve this carbonate material, leaving the other constituents in the shale quite unaffected. Therefore, when using the process of the invention, the disadvantages caused by many fines, which are primarily to do with fines migration causing particles suspended in the produced fluid to bridge the pore throats near the wellbore, and so reducing well productivity, can be largely avoided. Damage created by fines usually is located within a radius of 3 to 5 ft [1 to 2 m] of the wellbore, but can also occur in gravel-pack completions. In addition, the process of the invention provides an improved permeability of the formation.

In addition, it was found that GLDA, MGDA and HEDTA are fully compatible with the clays present in the shale and do not induce clay swelling, in contrast to HCl. Clay swelling, the process in which a liquid is absorbed between the layers of the clay, results in an increase in the volume of the clay particles and can thus result in the blockage of the narrow pores, reducing the permeability of the formation and thus ultimately leading to a reduced flow of oil and/ or gas towards the wellbore.

In a preferred embodiment the process of the invention involves an additional fracturing step (when the fluid of the invention is acidic to give an acidic fracturing process). Accordingly, the invention also relates to a process for treating a shale formation comprising a step of fracturing the shale formation and a step of introducing a fluid containing glutamic acid N,N-diacetic acid or a salt thereof (GLDA), methylglycine N,N-diacetic acid or a salt thereof (MGDA), and/or N-hydroxyethyl ethylenediamine N,N′,N′-triacetic acid or a salt thereof (HEDTA) into the formation, wherein the fracturing step can take place before introducing the fluid into the formation, while introducing the fluid into the formation or subsequent to introducing the fluid into the formation.

If fracturing takes place while introducing the fluid into the formation, the fluid containing GLDA, MGDA, and/or HEDTA can function as both the treatment and the fracturing fluid and will be introduced into the formation under a pressure above the fracture pressure of the treated formation. In this way, the process has a real economic benefit as instead of two fluids only one fluid needs to be used.

It was found that a fracturing step gives the fluid a better flow through the formation, and makes it possible for a higher area of the formation to be treated with the fluid containing GLDA, MGDA, and/or HEDTA, thus enabling a higher oil and/or gas production from the shale.

In addition, the fluid containing GLDA, MGDA, and/or HEDTA was found to be very suitable for recycling fracturing fluid and transporting particles, fines, deposits created by fracturing the shale formation. For example, the fluid containing GLDA, MGDA, and/or HEDTA was found to be useful in keeping the fractures formed by the fracturing step open and in addition capable of transporting any particles, fines, deposits outside the formation, while at the same time it was found to be capable of creating further channels into the formation as well as etched surfaces thereon by dissolving certain acid-soluble constituents, like carbonates, in the shale.

In addition, it was found that the fluid containing GLDA, MGDA and/or HEDTA does not weaken the shale, increasing the longevity of the formed fractures as they are less prone to closure due to the formation pressure.

In addition it was established that in the processes of the present invention the fluid used does not only increase the permeability but also plays a role in limiting swelling of the shale which swelling would negatively affect the created permeability improvement.

Moreover, it was found that the fluids of the invention are very suitable for desorbing the kerogen, gas and/or oil from the shale formation and are additionally compatible to a high extent with the kerogen, crude oil and/or gas. Contrary to what is suggested in prior art documents when treating shale with chelating agents, when using the fluids of the present invention less heating is needed as the fluids of the present invention have a much more favourable pH profile and are so compatible with the oil, gas, and organics to which they are adsorbed that they need not be liquefied to the same extent by heat but give a good desorption and flow at a much lower temperature already.

In addition, the fluids of the present invention require much lower amounts of—and sometimes even can do without—certain additives, like especially antisludge additives, corrosion inhibitors, and corrosion inhibitor intensifiers. Especially when the fluids of the present invention have a low pH, they need significantly lower amounts of these additives while having the same effectiveness.

The GLDA, MGDA, and/or HEDTA are preferably used in an amount of between 1 and 30 wt %, more preferably between 3 and 30 wt %, even more preferably between 5 and 20 wt %, on the basis of the total weight of the fluid.

Salts of GLDA, MGDA, and/or HEDTA that can be used are their alkali metal, alkaline earth metal, or ammonium full and partial salts. Also mixed salts containing different cations can be used. Preferably, the sodium, potassium, and ammonium full or partial salts of GLDA, MGDA, and/or HEDTA are used.

In a preferred embodiment GLDA is used, as this material gives clearly the best results. This is amongst others because it was found that HEDTA leaches iron from the chlorite clay minerals more than it leaches calcium from calcite. Leaching more iron from chlorite may cause some fines migration. If the shale formation contains high percentage of chlorite, it is not advised to use HEDTA. In addition, MGDA also does not give as good results as GLDA because it is not as selective on calcite as GLDA. Another advantage of both GLDA and HEDTA is that these compounds are better for use in higher concentrations, in the case of GLDA in even more concentrated form than any of the other chelating agents over a broad pH range.

The fluids of the invention are preferably aqueous fluids, i.e. they preferably contain water as a solvent for the other ingredients, though other solvents may be added as well, as further explained below.

The pH of the fluids of the invention can range from 1.7 to 14. Preferably, however, it is between 3 and 13, as in the very acidic ranges of 1.7 to 3 and the very alkaline range of 13 to 14 some undesired side effects may be caused by the fluids in the formation, such as too fast dissolution of carbonate giving excessive CO₂ formation or an increased risk of reprecipitation. For a better carbonate dissolving capacity the pH is preferably acidic. On the other hand, it must be realized that highly acidic solutions are more expensive to well tubulars. Consequently, the solution even more preferably has a pH of 3 to 6.

The shale formation contains preferably at least a portion of a calcareous shale type.

The fluid may contain other additives that improve the functionality of the stimulation action and minimize the risk of damage as a consequence of the said treatment, as is known to anyone skilled in the art.

The fluid of the invention may in addition contain one or more of the group of anti-sludge agents, (water-wetting or emulsifying) surfactants, corrosion inhibitors, mutual solvents, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives such as further acids and/or bases, bactericides/biocides, particulates, crosslinkers, salt substitutes (such as tetramethyl ammonium chloride), relative permeability modifiers, sulfide scavengers, fibres, nanoparticles, consolidating agents (such as resins and/or tackifiers), combinations thereof, or the like.

The mutual solvent is a chemical liquid additive that is soluble in oil, water, acids (often HCI based), and other well treatment fluids, (see also http://www.glossary.oilfield.slb.com). In many cases the mutal solvent makes that the oil and water based liquids which are ordinarily immiscible liquids combine with each other, and in preferred embodiments form a clear solution. Mutual solvents are routinely used in a range of applications, controlling the wettability of contact surfaces before, during and/or after a treatment, and preventing or breaking emulsions. Mutual solvents are used, as insoluble formation fines pick up organic film from crude oil. These particles are partially oil-wet and partially water-wet. This causes them to collect materials at any oil-water interface, which can stabilize various oil-water emulsions. Mutual solvents remove organic films leaving them water-wet, thus emulsions and particle plugging are eliminated. If a mutual solvent is employed, it is preferably selected from the group which includes, but is not limited to, lower alcohols such as methanol, ethanol, 1-propanol, 2-propanol, and the like, glycols such as ethylene glycol, propylene glycol, diethylene glycol, dipropylene glycol, polyethylene glycol, polypropylene glycol, polyethylene glycol-polyethylene glycol block copolymers, and the like, and glycol ethers such as 2-methoxyethanol, diethylene glycol monomethyl ether, and the like, substantially water/oil-soluble esters, such as one or more C2-esters through C10-esters, and substantially water/oil-soluble ketones, such as one or more C2-C10 ketones. The mutual solvent is preferably present in an amount of 1 to 50 wt % on total fluid.

A preferred water/oil-soluble ketone is methyl ethyl ketone.

A preferred substantially water/oil-soluble alcohol is methanol.

A preferred substantially water/oil-soluble ester is methyl acetate.

A more preferred mutual solvent is ethylene glycol monobutyl ether, generally known as EGMBE

The amount of glycol solvent in the solution is preferably about 1 wt % to about 10 wt %, more preferably between 3 and 5 wt %. More preferably, the ketone solvent may be present in an amount from 40 wt % to about 50 wt %; the substantially water-soluble alcohol may be present in an amount within the range of about 20 wt % to about 30 wt %; and the substantially water/oil-soluble ester may be present in an amount within the range of about 20 wt % to about 30 wt %, each amount being based upon the total weight of the solvent in the fluid.

In one embodiment the mutual solvent can be used as a preflush or postflush material, i.e. in such embodiment will be introduced into the formation before or after the treatment with the treatment fluid.

The surfactant can be any surfactant known in the art and can be nonionic, cationic, anionic, and zwitterionic. Preferably, the surfactant is nonionic or anionic. Even more preferably, the surfactant is anionic.

The nonionic surfactant of the present composition is preferably selected from the group consisting of alkanolamides, alkoxylated alcohols, alkoxylated amines, amine oxides, alkoxylated amides, alkoxylated fatty acids, alkoxylated fatty amines, alkoxylated alkyl amines (e.g., cocoalkyl amine ethoxylate), alkyl phenyl polyethoxylates, lecithin, hydroxylated lecithin, fatty acid esters, glycerol esters and their ethoxylates, glycol esters and their ethoxylates, esters of propylene glycol, sorbitan, ethoxylated sorbitan, polyglycosides and the like, and mixtures thereof. Alkoxylated alcohols, preferably ethoxylated alcohols, optionally in combination with (alkyl) polyglycosides, are the most preferred nonionic surfactants.

The anionic (sometimes zwitterionic, as two charges are combined into one compound) surfactants may comprise any number of different compounds, including sulfonates, hydrolyzed keratin, sulfosuccinates, taurates, betaines, modified betaines, alkylamidobetaines (e.g., cocoamidopropyl betaine).

Examples of surfactants that are also foaming agents that may be utilized to foam and stabilize the treatment fluids of this invention include, but are not limited to, betaines, amine oxides, methyl ester sulfonates, alkylamidobetaines such as cocoamidopropyl betaine, alpha-olefin sulfonate, trimethyl tallow ammonium chloride, C8 to C22 alkyl ethoxylate sulfate, and trimethyl coco ammonium chloride.

Suitable surfactants may be used in a liquid or powder form. Where used, the surfactants may be present in the fluid in an amount sufficient to prevent incompatibility with formation fluids, other treatment fluids, or wellbore fluids at reservoir temperature. In an embodiment where liquid surfactants are used, the surfactants are generally present in an amount in the range of from about 0.01% to about 5.0% by volume of the fluid. In one embodiment, the liquid surfactants are present in an amount in the range of from about 0.1% to about 2.0% by volume of the fluid, more preferably between 0.1 and 1 volume %.

In embodiments where powdered surfactants are used, the surfactants may be present in an amount in the range of from about 0.001% to about 0.5% by weight of the fluid.

The antisludge agent can be chosen from the group of mineral and/or organic acids as also used to stimulate hydrocarbon bearing formations. The function of the acid is to dissolve acid-soluble materials so as to clean or enlarge the flow channels of the formation leading to the wellbore, allowing more oil and/or gas to flow to the wellbore.

Problems are caused by the interaction of the (usually concentrated, 20-28% HCl) stimulation acid and certain crude oils (e.g. asphaltic oils) in the formation to form sludge. Interaction studies between sludging crude oils and the introduced acid show that permanent rigid solids are formed at the acid-oil interface when the aqueous phase is below a pH of about 4. No films are observed for non-sludging crudes with acid.

These sludges are usually reaction products formed between the acid and the high molecular weight hydrocarbons such as asphaltenes, resins, etc. Methods for preventing or controlling sludge formation with its attendant flow problems during the acidization of crude-containing formations include adding “anti-sludge” agents to prevent or reduce the rate of formation of crude oil sludge, which anti-sludge agents stabilize the acid-oil emulsion and include alkyl phenols, fatty acids, and anionic surfactants. Frequently used as the surfactant is a blend of a sulfonic acid derivative and a dispersing surfactant in a solvent. Such a blend generally has dodecyl benzene sulfonic acid (DDBSA) or a salt thereof as the major dispersant, i.e. anti-sludge, component.

The carrier fluids are aqueous solutions which in certain embodiments contain a Bronsted acid to keep the pH in the desired range and/or contain an inorganic salt, preferably NaCl or KCl.

Corrosion inhibitors may be selected from the group of amine and quaternary ammonium compounds and sulfur compounds. Examples are diethyl thiourea (DETU), which is suitable up to 185° F. (about 85° C.), alkyl pyridinium or quinolinium salt, such as dodecyl pyridinium bromide (DDPB), and sulfur compounds, such as thiourea or ammonium thiocyanate, which are suitable for the range 203-302° F. (about 95-150° C.), benzotriazole (BZT), benzimidazole (BZI), dibutyl thiourea, a proprietary inhibitor called TIA, and alkyl pyridines.

In general, the most successful inhibitor formulations for organic acids and chelating agents contain amines, reduced sulfur compounds or combinations of a nitrogen compound (amines, quats or polyfunctional compounds), and a sulfur compound. The amount of corrosion inhibitor is preferably less than 2 volume %, more preferably between 0.01 and 1 volume %, even more preferably between 0.1 and 1 volume % on total fluid.

One or more corrosion inhibitor intensifiers may be added, such as for example formic acid, potassium iodide, antimony chloride, or copper iodide.

One or more salts may be used as rheology modifiers to modify the rheological properties (e.g., viscosity and elastic properties) of the treatment fluids. These salts may be organic or inorganic.

Examples of suitable organic salts include, but are not limited to, aromatic sulfonates and carboxylates (such as p-toluene sulfonate and naphthalene sulfonate), hydroxynaphthalene carboxylates, salicylate, phthalate, chlorobenzoic acid, phthalic acid, 5-hydroxy-1-naphthoic acid, 6-hydroxy-1-naphthoic acid, 7-hydroxy-1-naphthoic acid, 1-hydroxy-2-naphthoic acid, 3-hydroxy-2-naphthoic acid, 5-hydroxy-2-naphthoic acid, 7-hydroxy-2-naphthoic acid, 1,3-dihydroxy-2-naphthoic acid, 3,4-dichlorobenzoate, trimethyl ammonium hydrochloride and tetramethyl ammonium chloride.

Examples of suitable inorganic salts include water-soluble potassium, sodium, and ammonium halide salts (such as potassium chloride and ammonium chloride), calcium chloride, calcium bromide, magnesium chloride, sodium formate, potassium formate, cesium formate, and zinc halide salts. A mixture of salts may also be used, but it should be noted that preferably chloride salts are mixed with chloride salts, bromide salts with bromide salts, and formate salts with formate salts.

Wetting agents that may be suitable for use in this invention include crude tall oil, oxidized crude tall oil, surfactants, organic phosphate esters, modified imidazolines and amidoamines, alkyl aromatic sulfates and sulfonates, and the like, and combinations or derivatives of these and similar such compounds that should be well known to one of skill in the art.

The foaming gas may be air, nitrogen or carbon dioxide. Nitrogen is preferred.

Gelling agents in a preferred embodiment are polymeric gelling agents.

Examples of commonly used polymeric gelling agents include, but are not limited to, biopolymers, polysaccharides such as guar gums and derivatives thereof, cellulose derivatives, synthetic polymers like polyacrylamides and viscoelastic surfactants, and the like. These gelling agents, when hydrated and at a sufficient concentration, are capable of forming a viscous solution.

When used to make an aqueous-based treatment fluid, a gelling agent is combined with an aqueous fluid and the soluble portions of the gelling agent are dissolved in the aqueous fluid, thereby increasing the viscosity of the fluid.

Viscosifiers may include natural polymers and derivatives such as xantham gum and hydroxyethyl cellulose (HEC) or synthetic polymers and oligomers such as poly(ethylene glycol) [PEG], poly(diallyl amine), poly(acrylamide), poly(amino-methyl propyl sulfonate) [AMPS polymer], poly(acrylonitrile), poly(vinyl acetate), poly(vinyl alcohol), poly(vinyl amine), poly(vinyl sulfonate), poly(styryl sulfonate), poly(acrylate), poly(methyl acrylate), poly(methacrylate), poly(methyl methacrylate), poly(vinyl pyrrolidone), poly(vinyl lactam) and co-, ter-, and quarter-polymers of the following (co-)monomers: ethylene, butadiene, isoprene, styrene, divinyl benzene, divinyl amine, 1,4-pentadiene-3-one (divinyl ketone), 1,6-heptadiene-4-one (diallyl ketone), diallyl amine, ethylene glycol, acrylamide, AMPS, acrylonitrile, vinyl acetate, vinyl alcohol, vinyl amine, vinyl sulfonate, styryl sulfonate, acrylate, methyl acrylate, methacrylate, methyl methacrylate, vinyl pyrrolidone, and vinyl lactam. Yet other viscosifiers include clay-based viscosifiers, especially laponite and other small fibrous clays such as the polygorskites (attapulgite and sepiolite). When using polymer-containing viscosifiers, the viscosifiers may be used in an amount of up to 5% by weight of the fluid.

Examples of suitable brines include calcium bromide brines, zinc bromide brines, calcium chloride brines, sodium chloride brines, sodium bromide brines, potassium bromide brines, potassium chloride brines, sodium nitrate brines, sodium formate brines, potassium formate brines, cesium formate brines, magnesium chloride brines, sodium sulfate, potassium nitrate, and the like. A mixture of salts may also be used in the brines, but it should be noted that preferably chloride salts are mixed with chloride salts, bromide salts with bromide salts, and formate salts with formate salts.

The brine chosen should be compatible with the formation and should have a sufficient density to provide the appropriate degree of well control.

Additional salts may be added to a water source, e.g., to provide a brine, and a resulting treatment fluid, in order to have a desired density.

The amount of salt to be added should be the amount necessary for formation compatibility, such as the amount necessary for the stability of clay minerals, taking into consideration the crystallization temperature of the brine, e.g., the temperature at which the salt precipitates from the brine as the temperature drops.

Preferred suitable brines may include seawater and/or formation brines.

Salts may optionally be included in the fluids of the present invention for many purposes, including for reasons related to compatibility of the fluid with the formation and the formation fluids. To determine whether a salt may be beneficially used for compatibility purposes, a compatibility test may be performed to identify potential compatibility problems.

From such tests, one of ordinary skill in the art will, with the benefit of this disclosure, be able to determine whether a salt should be included in a treatment fluid of the present invention.

Suitable salts include, but are not limited to, calcium chloride, sodium chloride, magnesium chloride, potassium chloride, sodium bromide, potassium bromide, ammonium chloride, sodium formate, potassium formate, cesium formate, and the like. A mixture of salts may also be used, but it should be noted that preferably chloride salts are mixed with chloride salts, bromide salts with bromide salts, and formate salts with formate salts.

The amount of salt to be added should be the amount necessary for the required density for formation compatibility, such as the amount necessary for the stability of clay minerals, taking into consideration the crystallization temperature of the brine, e.g., the temperature at which the salt precipitates from the brine as the temperature drops.

Salt may also be included to increase the viscosity of the fluid and stabilize it, particularly at temperatures above 180° F. (about 82° C.).

Examples of suitable pH control additives which may optionally be included in the treatment fluids of the present invention are acid compositions and/or bases.

A pH control additive may be necessary to maintain the pH of the treatment fluid at a desired level, e.g., to improve the effectiveness of certain breakers and to reduce corrosion on any metal present in the wellbore or formation, etc.

One of ordinary skill in the art will, with the benefit of this disclosure, be able to recognize a suitable pH for a particular application.

In one embodiment, the pH control additive may be an acid composition.

Examples of suitable acid compositions may comprise an acid, an acid-generating compound, and combinations thereof.

Any known acid may be suitable for use with the treatment fluids of the present invention.

Examples of acids that may be suitable for use in the present invention include, but are not limited to, organic acids (e.g., formic acids, acetic acids, carbonic acids, citric acids, glycolic acids, lactic acids, ethylene diamine tetraacetic acid (EDTA), and the like), inorganic acids (e.g., hydrochloric acid, hydrofluoric acid, phosphonic acid, p-toluene sulfonic acid, and the like), and combinations thereof. Preferred acids are HCl (to an amount compatible with the illite content) and organic acids. Examples of acid-generating compounds that may be suitable for use in the present invention include, but are not limited to, esters, aliphatic polyesters, ortho esters, which may also be known as ortho ethers, poly(ortho esters), which may also be known as poly(ortho ethers), poly(lactides), poly(glycolides), poly(epsilon-caprolactones), poly(hydroxybutyrates), poly(anhydrides), or copolymers thereof. Derivatives and combinations also may be suitable.

The term “copolymer” as used herein is not limited to the combination of two polymers, but includes any combination of polymers, e.g., terpolymers and the like.

Other suitable acid-generating compounds include: esters including, but not limited to, ethylene glycol monoformate, ethylene glycol diformate, diethylene glycol diformate, glyceryl monoformate, glyceryl diformate, glyceryl triformate, methylene glycol diformate, and formate esters of pentaerythritol.

The pH control additive also may comprise a base to elevate the pH of the fluid. Generally, a base may be used to elevate the pH of the mixture to greater than or equal to about 7.

Having the pH level at or above 7 may have a positive effect on a chosen breaker being used and may also inhibit the corrosion of any metals present in the wellbore or formation, such as tubing, screens, etc.

In addition, having a pH greater than 7 may also impart greater stability to the viscosity of the treatment fluid, thereby enhancing the length of time that viscosity can be maintained.

This could be beneficial in certain uses, such as in longer-term well control and in diverting.

Any known base that is compatible with the gelling agents of the present invention can be used in the fluids of the present invention.

Examples of suitable bases include, but are not limited to, sodium hydroxide, potassium carbonate, potassium hydroxide, sodium carbonate, and sodium bicarbonate.

One of ordinary skill in the art will, with the benefit of this disclosure, recognize the suitable bases that may be used to achieve a desired pH elevation.

In some embodiments, the treatment fluid may optionally comprise a further chelating agent.

When added to the treatment fluids of the present invention, the chelating agent may chelate any dissolved iron (or other divalent or trivalent cation) that may be present in the aqueous fluid and prevent any undesired reactions being caused.

Such chelating agent may e.g. prevent such ions from crosslinking the gelling agent molecules.

Such crosslinking may be problematic because, inter alia, it may cause filtration problems, injection problems, and/or cause permeability problems once more.

Any suitable chelating agent may be used with the present invention.

Examples of suitable chelating agents include, but are not limited to, citric acid, nitrilotriacetic acid (NTA), any form of ethylene diamine tetraacetic acid (EDTA), diethylene triamine pentaacetic acid (DTPA), propylene diamine tetraacetic acid (PDTA), ethylene diamine-N,N″-di(hydroxyphenylacetic) acid (EDDHA), ethylene diamine-N,N″-di-(hydroxy-methylphenyl acetic acid (EDDH MA), ethanol diglycine (EDG), trans-1,2-cyclohexylene dinitrilotetraacetic acid (CDTA), glucoheptonic acid, gluconic acid, sodium citrate, phosphonic acid, salts thereof, and the like.

In some embodiments, the chelating agent may be a sodium, potassium or ammonium salt.

Generally, the chelating agent may be present in an amount sufficient to prevent undesired side effects of divalent or trivalent cations that may be present, and thus also functions as a scale inhibitor.

One of ordinary skill in the art will, with the benefit of this disclosure, be able to determine the proper concentration of a chelating agent for a particular application.

In some embodiments, the fluids of the present invention may contain bactericides or biocides, inter alia, to protect the subterranean formation as well as the fluid from attack by bacteria. Such attacks can be problematic because they may lower the viscosity of the fluid, resulting in poorer performance, such as poorer sand suspension properties, for example.

Any bactericides known in the art are suitable. Biocides and bactericides that protect against bacteria that may attack GLDA, MGDA, HEDTA, or sulfates are preferred

An artisan of ordinary skill will, with the benefit of this disclosure, be able to identify a suitable bactericide and the proper concentration of such bactericide for a given application.

Examples of suitable bactericides and/or biocides include, but are not limited to, phenoxyethanol, ethylhexyl glycerine, benzyl alcohol, methyl chloroisothiazolinone, methyl isothiazolinone, methyl paraben, ethyl paraben, propylene glycol, bronopol, benzoic acid, imidazolinidyl urea, a 2,2-dibromo-3-nitrilopropionamide, and a 2-bromo-2-nitro-1,3-propane diol. In one embodiment, the bactericides are present in the fluid in an amount in the range of from about 0.001% to about 1.0% by weight of the fluid.

Fluids of the present invention also may comprise breakers capable of reducing the viscosity of the fluid at a desired time.

Examples of such suitable breakers for fluids of the present invention include, but are not limited to, oxidizing agents such as sodium chlorites, sodium bromate, hypochlorites, perborate, persulfates, and peroxides, including organic peroxides.

Other suitable breakers include, but are not limited to, suitable acids and peroxide breakers, triethanol amine, as well as enzymes that may be effective in breaking. The breakers can be used as is or encapsulated.

Examples of suitable acids may include, but are not limited to, hydrochloric acid, hydrofluoric acid, formic acid, acetic acid, citric acid, lactic acid, glycolic acid, etc, and combinations of these acids.

A breaker may be included in a treatment fluid of the present invention in an amount and form sufficient to achieve the desired viscosity reduction at a desired time.

The breaker may be formulated to provide a delayed break, if desired.

The fluids of the present invention also may comprise suitable fluid loss additives. Such fluid loss additives may be particularly useful when a fluid of the present invention is used in a fracturing application or in a fluid used to seal a formation against invasion of fluid from the wellbore.

Any fluid loss agent that is compatible with the fluids of the present invention is suitable for use in the present invention.

Examples include, but are not limited to, starches, silica flour, gas bubbles (energized fluid or foam), benzoic acid, soaps, resin particulates, relative permeability modifiers, degradable gel particulates, diesel or other hydrocarbons dispersed in fluid, and other immiscible fluids.

Another example of a suitable fluid loss additive is one that comprises a degradable material.

Suitable examples of degradable materials include polysaccharides such as dextran or cellulose; chitins; chitosans; proteins; aliphatic polyesters; poly(lactides); poly(glycolides); poly(glycolide-co-lactides); poly(epsilon-caprolactones); poly(3-hydroxybutyrates); poly(3-hydroxybutyrate-co-hydroxyvalerates); poly(anhydrides); aliphatic poly(carbonates); poly(ortho esters); poly(amino acids); poly(ethylene oxides); poly(phosphazenes); derivatives thereof; or combinations thereof.

In some embodiments, a fluid loss additive may be included in an amount of about 5 to about 2,000 lbs/Mgal (about 600 to about 240,000 g/Mliter) of the fluid.

In some embodiments, the fluid loss additive may be included in an amount from about 10 to about 50 lbs/Mgal (about 1,200 to about 6,000 g/Mliter) of the fluid.

In certain embodiments, a stabilizer may optionally be included in the fluids of the present invention.

It may be particularly advantageous to include a stabilizer if a chosen fluid is experiencing viscosity degradation.

One example of a situation where a stabilizer might be beneficial is where the BHT (bottom hole temperature) of the wellbore is sufficient to break the fluid by itself without the use of a breaker.

Suitable stabilizers include, but are not limited to, sodium thiosulfate, methanol, and salts such as formate salts and potassium or sodium chloride.

Such stabilizers may be useful when the fluids of the present invention are utilized in a subterranean formation having a temperature above about 200° F. (about 93° C.). If included, a stabilizer may be added in an amount of from about 1 to about 50 lbs/Mgal (about 120 to about 6,000 g/Mliter) of fluid.

Scale inhibitors may be added to the fluids of the present invention, for example, when such fluids are not particularly compatible with the formation waters in the formation in which they are used.

These scale inhibitors may include water-soluble organic molecules with carboxylic acid, aspartic acid, maleic acids, sulfonic acids, phosphonic acid, and phosphate ester groups including copolymers, ter-polymers, grafted copolymers, and derivatives thereof.

Examples of such compounds include aliphatic phosphonic acids such as diethylene triamine penta (methylene phosphonate) and polymeric species such as polyvinyl sulfonate.

The scale inhibitor may be in the form of the free acid but is preferably in the form of mono- and polyvalent cation salts such as Na, K, Al, Fe, Ca, Mg, NH₄. Any scale inhibitor that is compatible with the fluid in which it will be used is suitable for use in the present invention.

Suitable amounts of scale inhibitors that may be included in the fluids of the present invention may range from about 0.05 to 100 gallons per about 1,000 gallons (i.e. 0.05 to 100 liters per 1,000 liters) of the fluid.

Any particulates such as proppant, gravel that are commonly used in subterranean operations in formations may be used in the present invention (e.g., sand, gravel, bauxite, ceramic materials, glass materials, wood, plant and vegetable matter, nut hulls, walnut hulls, cotton seed hulls, cement, fly ash, fibrous materials, composite particulates, hollow spheres and/or porous proppant).

It should be understood that the term “particulate” as used in this disclosure includes all known shapes of materials including substantially spherical materials, oblong, fibre-like, ellipsoid, rod-like, polygonal materials (such as cubic materials), mixtures thereof, derivatives thereof, and the like.

In some embodiments, coated particulates may be suitable for use in the treatment fluids of the present invention. It should be noted that many particulates also act as diverting agents. Further diverting agents are viscoelastic surfactants and in-situ gelled fluids.

Oxygen scavengers may be needed to enhance the thermal stability of the GLDA, MGDA, HEDTA or NTA. Examples thereof are sulfites and ethorbates.

Friction reducers can be added in an amount of up to 0.2 vol %. Suitable examples are viscoelastic surfactants and enlarged molecular weight polymers.

Crosslinkers can be chosen from the group of multivalent cations that can crosslink polymers such as Al, Fe, B, Ti, Cr, and Zr, or organic crosslinkers such as polyethylene amides, formaldehyde.

Sulfide scavengers can suitably be an aldehyde or ketone.

Viscoelastic surfactants can be chosen from the group of amine oxides or carboxyl betaine based surfactants.

The fluids can be used at basically any temperature encountered when treating a subterranean formation. Though subterranean formations normally have a temperature higher than room temperature, due to the fact that they sometimes are accessed through deep sea water, this means in practice a temperature of between 35 and 400° F. (about 2 and 204° C.). Preferably, the fluids are used at a temperature where they best achieve the desired effects, which means a temperature of between 77 and 300° F. (about 25 and 149° C.).

High temperature applications may benefit from the presence of an oxygen scavenger in an amount of less than about 2 volume percent of the solution.

At the same time the fluids can be used at an increased pressure. Often fluids are pumped into the formation under pressure. Preferably, the pressure used is below fracture pressure, i.e. the pressure at which a specific formation is susceptible to fracture. Fracture pressure can vary a lot depending on the formation treated, but is well known by the person skilled in the art.

In the process of the invention the fluid can be flooded back from the formation. Even more preferably, (part of) the solution is recycled.

It must be realized, however, that GLDA, and MGDA, being biodegradable chelating agents, will not flow back completely and therefore are not recyclable to the full extent.

1. A process for treating a shale formation comprising introducing a fluid containing glutamic acid N,N-diacetic acid or a salt thereof (GLDA), methylglycine N,N-diacetic acid or a salt thereof (MGDA), and/or N-hydroxyethyl ethylenediamine N,N′,N′-triacetic acid or a salt thereof (HEDTA) into the formation.

2. The process for treating a shale formation of claim 1 comprising an additional step of fracturing the shale formation wherein the fracturing step can take place before introducing the fluid into the formation, while introducing the fluid into the formation or subsequent to introducing the fluid into the formation

3. The process of claim 2, wherein the fluid containing glutamic acid N,N-diacetic acid or a salt thereof (GLDA), methylglycine N,N-diacetic acid or a salt thereof (MGDA), and/or N-hydroxyethyl ethylenediamine N,N′,N′-triacetic acid or a salt thereof (HEDTA) is also the fracturing fluid in the fracturing step.

4. The process of claim 1, wherein the fluid contains between 3 and 30 wt % of GLDA, MGDA, and/or HEDTA based on the total weight of the fluid.

5. The process of claim 1, wherein the fluid contains GLDA.

6. The process of claim 1, wherein the fluid has a pH of between 3 and 13.

7. The process of claim 6, wherein the pH is between 3 and 6.

8. The process of claim 1, wherein the process is done at a temperature of between 77 and 300° F. (about 25 and 149° C.).

9. The process of claim 1, wherein the fluid contains water as a solvent.

10. The process of claim 1, wherein the fluid in addition contains a further additive selected from the group consisting of solvents, alcohols, glycols, organic solvents, mutual solvents, anti-sludge agents, surfactants, corrosion inhibitors, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives, bactericides/biocides, particulates, crosslinkers, salt substitutes, relative permeability modifiers, sulfide scavengers, fibres, nanoparticles, and consolidating agents.

11. The process of claim 10, wherein the surfactant is a nonionic or anionic surfactant.

12. The process of claim 10, wherein the surfactant is present in an amount of 0.1 to 2 volume % on total fluid volume.

13. The process of claim 10, wherein the corrosion inhibitor is present in an amount of 0.01 to 2 volume % on total fluid volume.

14. The process of claim 10, wherein the mutual solvent is present in an amount of 1 to 50 wt % on total fluid weight.

15. The process of claim 5, wherein the pH is between 3 and 6.
